(19) United States
(12) Patent Application Publication
(10) Pub. No.: US 2026/0356029 A1
(43) Pub. Date: Nov. 12, 2026

(54) Methods For Thermoforming Multiwall Thermoplastic Sheet and Aircraft Components Formed Therefrom

(71) Applicant: Bantam Aero, LLC, Cook, WA (US)

(72) Inventor: Robert Scott Coatney, White Salmon, WA (US)

(73) Assignee: Bantam Aero, LLC, Cook, WA (US)

(21) Appl. No.: 19/670,336

(22) Filed: May 7, 2026

Related U.S. Application Data
(60) Provisional application No. 63/803,254, filed on May 9, 2025.

(51) Int. Cl. B29C 51/10; B29C 31/04; B29C 51/00; B29C 51/04; B29C 55/02; B29C 65/00; B29K 69/00; B29L 31/30

(52) U.S. Cl. CPC B29C 51/10; B29C 31/04; B29C 51/002; B29C 51/04; B29C 55/02; B29C 65/00; B29K 2069/00; B29L 2031/3085

(57) ABSTRACT

A method for manufacturing a component part comprises providing a sheet of multiwall thermoplastic material comprising a first wall having a first planar surface, a second wall having a second planar surface, and internal web walls extending therebetween. The sheet is heated until pliable and positioned between first and second mold halves of a vacuum mold. The vacuum mold is closed and vacuum suction is applied to both mold halves simultaneously to draw the planar surfaces against respective mold surfaces, thereby forming a shaped component. The shaped component is removed from the vacuum mold. An aircraft component comprises a structural body formed from a sheet of multiwall thermoplastic material transformed from a flat configuration into a three-dimensional shape by thermoforming such that the first planar surface defines a first formed surface and the second planar surface defines a second surface.

### CROSS-REFERENCE TO RELATED APPLICATIONS

This application claims the benefit of U.S. Provisional Application No. 63/803,254, filed May 9, 2025, the entire disclosure of which is incorporated herein by reference.

### FIELD OF INVENTION

The present disclosure relates to methods and materials for manufacturing component parts from thermoplastic sheet material, and more particularly to thermoforming multiwall thermoplastic sheets using vacuum molds to produce aircraft components and other products.

### BACKGROUND

Small fixed-wing unmanned aerial vehicles (UAVs) and radio-controlled (RC) aircraft have become increasingly prevalent in both commercial and defense applications. These aircraft serve a variety of missions including intelligence, surveillance, and reconnaissance (ISR) operations, as well as other tactical applications. Advances in autonomy and communication technologies have expanded the operational capabilities of these platforms, enabling them to operate at extended ranges of 40 kilometers and beyond from their launch points.

The demand for fixed-wing drone airframes has grown substantially as these platforms offer advantages over rotary-wing alternatives for missions requiring extended range and endurance. However, current manufacturing methods for fixed-wing drone airframes present various challenges. Carbon fiber construction, while offering favorable strength-to-weight characteristics, tends to be expensive and labor intensive. Three-dimensional printing processes can be slow, may result in parts that are heavier and weaker than desired, and often require substantial assembly. Expanded polypropylene (EPP) foam molding requires large and expensive equipment and may yield parts with limited structural properties.

Thermoforming, also known as vacuum forming, is a well-established manufacturing process to shape thermoplastic materials. In conventional thermoforming, a sheet of thermoplastic material is heated until pliable and then formed against a mold surface using vacuum pressure. This process is capable of producing parts with complex geometries at relatively low cost and high production rates. However, parts produced by conventional thermoforming of single-wall thermoplastic sheets tend to be flimsy and lack the structural rigidity required for load-bearing applications without additional reinforcement or support structures.

Multiwall thermoplastic sheeting, sometimes referred to as corrugated or fluted plastic, comprises multiple parallel planar surfaces connected by internal web walls. This material configuration provides enhanced panel stiffness compared to single-wall materials of equivalent weight. Multiwall sheets are commercially available in various thermoplastic materials including polycarbonate and polypropylene, and are commonly used in applications such as greenhouse construction and signage.

Thermoforming processes have not been applied to multiwall thermoplastic materials, as conventional thermoforming techniques are designed for single-wall sheet materials. Accordingly, there remains an opportunity for improved methods and materials for manufacturing aircraft components and other products that leverage the benefits of thermoforming while enabling the use of multiwall thermoplastic materials.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for manufacturing a component part is provided. The method comprises providing a sheet of multiwall thermoplastic material. The multiwall thermoplastic material comprises a first wall having a first planar surface, a second wall having a second planar surface spaced apart from the first planar surface, and a plurality of internal web walls extending between the first wall and the second wall. The method further comprises heating the sheet until the multiwall thermoplastic material becomes pliable. The method further comprises positioning the heated sheet between a first mold half and a second mold half of a vacuum mold, wherein the first mold half defines a first mold surface and the second mold half defines a second mold surface. The method further comprises closing the vacuum mold to compress the heated sheet between the first mold half and the second mold half. The method further comprises applying vacuum suction to both the first mold half and the second mold half simultaneously to draw the first planar surface against the first mold surface and the second planar surface against the second mold surface, thereby forming a shaped component. The method further comprises removing the shaped component from the vacuum mold.

According to other aspects of the present disclosure, the method may include one or more of the following features. The internal web walls may be stretched during forming and may cool to provide structural support between the first wall and the second wall. The first mold half and the second mold half may be coupled by a pivotable coupling. A shape of the first mold surface may be different from a shape of the second mold surface. The first mold surface may be a smooth, uniform surface, and the second mold surface may comprise at least one recess configured to form a corresponding channel in the shaped component for receiving an internal aircraft component. The internal aircraft component may comprise a structural support. The structural support may comprise a spar. The at least one recess may be configured to form at least one of: a slot for receiving a wing spar or wing rib, a planar mounting surface for internal equipment, and a non-planar recess for indexing or mounting equipment. The method may further comprise forming a second shaped component and bonding the shaped component to the second shaped component to form an assembled structure. The method may further comprise positioning a spar between the shaped component and the second shaped component prior to bonding, wherein the spar is received within channels formed in the shaped component and the second shaped component. The shaped component may comprise a wing skin having an upper surface portion and a lower surface portion formed as a single contiguous piece, and the method may further comprise folding the wing skin about a leading edge to bring the upper surface portion and the lower surface portion into opposition, and bonding the upper surface portion to the lower surface portion along a trailing edge to form a wing. The method may further comprise securing the sheet in a frame prior to heating. The multiwall thermoplastic material may comprise at least one of polycarbonate and polypropylene.

According to another aspect of the present disclosure, an aircraft component is provided. The aircraft component comprises a structural body formed from a sheet of multiwall thermoplastic material. The multiwall thermoplastic material comprises a first wall having a first planar surface, a second wall having a second planar surface spaced apart from the first planar surface, and a plurality of internal web walls extending between the first wall and the second wall. The sheet of multiwall thermoplastic material has been transformed from an originally flat configuration into a three-dimensional shape by thermoforming such that the first planar surface defines a first formed surface, and the second planar surface defines a second surface.

According to other aspects of the present disclosure, the aircraft component may include one or more of the following features. The second surface may comprise at least one slot configured to receive at least one of a wing spar and a wing rib. The second surface may comprise at least one mounting feature configured for receiving an internal component. The at least one mounting feature may comprise at least one of a planar mounting surface and a non-planar recess. The internal component may comprise at least one of a battery, a flight controller, a mission payload, a radio, a servo, a motor mount, and a fuel tank. The internal web walls may have been stretched during thermoforming and may have cooled to provide structural support between the first wall and the second wall. The multiwall thermoplastic material may comprise at least one of polycarbonate and polypropylene.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a thermoformed wing section made from multiwall thermoplastic sheet material, according to aspects of the present disclosure.

FIG. 2A illustrates a perspective view of a delta wing aircraft assembled from thermoformed multiwall material, according to aspects of the present disclosure.

FIG. 2B illustrates a side view of the delta wing aircraft of FIG. 2A, according to an embodiment.

FIG. 2C illustrates a view of the delta wing aircraft of FIG. 2A showing internal components, according to an embodiment.

FIG. 3A illustrates a perspective view of a multiwall material with internal structure visible, according to aspects of the present disclosure.

FIG. 3B illustrates a perspective view of the multiwall material of FIG. 3A with web walls emphasized, according to an embodiment.

FIG. 3C illustrates a schematic isometric view of the multiwall material shown as opaque, according to an embodiment.

FIG. 3D illustrates a perspective view of the multiwall material as polypropylene, according to an embodiment.

FIG. 3E illustrates a perspective view of the multiwall material as polycarbonate, according to an embodiment.

FIG. 4A illustrates example multiwall profiles showing various web wall configurations, according to aspects of the present disclosure.

FIG. 4B illustrates a table of mechanical and thermal properties for multiwall polycarbonate profiles, according to aspects of the present disclosure.

FIG. 5 illustrates a thermoforming process for forming multiwall sheets into shaped components, according to aspects of the present disclosure.

FIG. 6 illustrates a flowchart for a method for making shaped component parts from multiwall thermoplastic material, according to aspects of the present disclosure.

FIG. 7 illustrates an exploded perspective view of a vacuum mold for a wing, according to aspects of the present disclosure.

FIG. 8A illustrates a cross-sectional view of the vacuum mold of FIG. 7 in an open configuration, according to an embodiment.

FIG. 8B illustrates a cross-sectional view of the vacuum mold of FIG. 7 in a closed configuration, according to an embodiment.

FIG. 9A illustrates an unassembled top wing portion and bottom wing portion of a wing, according to aspects of the present disclosure.

FIG. 9B illustrates the wing of FIG. 9A in an assembled configuration with a spar, according to an embodiment.

FIG. 10 illustrates a flowchart for a method for assembling a wing from two thermoformed multiwall sheet halves, according to aspects of the present disclosure.

FIG. 11 illustrates a cross-sectional view of an unassembled wing portion formed with a flattened contiguous profile, according to aspects of the present disclosure.

FIG. 12 illustrates a flowchart for a method for making a wing from a single thermoformed multiwall sheet by folding, according to aspects of the present disclosure.

FIG. 13 illustrates a cross section of a fuselage with two halves joined together, according to aspects of the present disclosure.

FIG. 14 illustrates a flowchart for a method for assembling a product from two thermoformed multiwall sheet components, according to aspects of the present disclosure.

FIG. 15 illustrates a one-piece formed stabilizer with camber formed from a multiwall plastic sheet, according to aspects of the present disclosure.

FIG. 16 illustrates a one-piece symmetrical stabilizer formed from a multiwall plastic sheet, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure describes methods and materials for manufacturing component parts from thermoplastic sheet material. In some aspects, the methods and materials disclosed herein relate to thermoforming multiwall thermoplastic sheets using vacuum molds to produce aircraft components and other products.

Multiwall thermoplastic sheeting comprises multiple parallel planar surfaces connected by internal web walls. This material configuration provides enhanced panel stiffness compared to single-wall materials of equivalent weight. Multiwall sheets are commercially available in various thermoplastic materials and may be used as source material for thermoforming processes.

In some aspects, a method for manufacturing a component part comprises providing a sheet of multiwall thermoplastic material, heating the sheet until the multiwall thermoplastic material becomes pliable, positioning the heated sheet between mold halves of a vacuum mold, and applying vacuum suction to draw the sheet against mold surfaces to form a shaped component. The internal web walls of the multiwall thermoplastic material may be stretched during forming and may cool to provide structural support within the shaped component.

In some cases, the vacuum mold comprises two mold halves that define respective mold surfaces. The heated multiwall sheet may be compressed between the mold halves, and vacuum suction may be applied to both mold halves simultaneously to form both surfaces of the multiwall sheet. This dual-mold arrangement allows the multiwall sheet to be shaped into components having complex three-dimensional geometries.

The methods and materials disclosed herein may be applied to manufacture various aircraft components, including wings, fuselages, stabilizers, and other structural elements. In some aspects, shaped components may be assembled together by bonding, such as with adhesives or plastic welding, to form larger structures. Internal components such as spars, fuel tanks, batteries, electronics, and other equipment may be accommodated within features formed into the shaped components during the thermoforming process.

### Thermoformed Wing Section

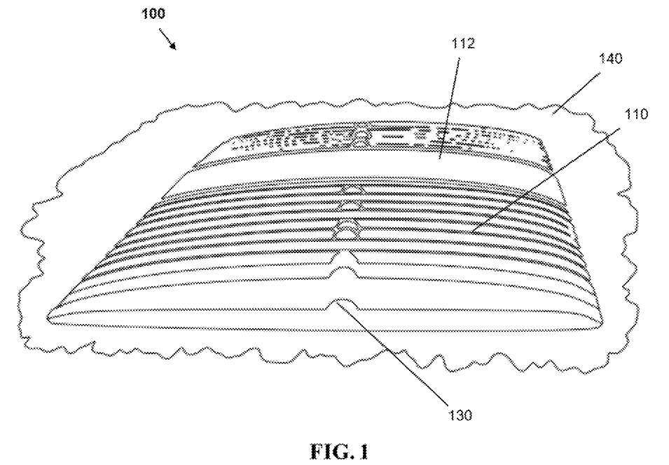

Referring to FIG. 1, a wing section 100 formed from multiwall polycarbonate thermoplastic sheet is shown. The wing section 100 has been thermoformed in a vacuum mold to produce a three-dimensional aerodynamic shape from the multiwall material.

The wing section 100 includes a top surface 110 that forms the aerodynamic exterior of the wing section 100. The top surface 110 corresponds to the outer planar surface of the multiwall thermoplastic material after thermoforming.

A cosmetic film skin 120 may be applied to the top surface 110 of the wing section 100. The cosmetic film skin 120 provides color and surface finish without requiring paint. In some cases, the cosmetic film skin 120 may be applied to the multiwall sheet prior to heating and insertion into the mold. In some cases, the cosmetic film skin 120 may be applied across the span of the finished wing after thermoforming.

A semicircular indentation on inner surface 130 is formed into the wing section 100 during the thermoforming process. The semicircular indentation on inner surface 130 is configured to locate and accommodate a cylindrical spar. In some cases, the semicircular indentation on inner surface 130 may be configured to accommodate other spar shapes as appropriate to the design of the wing.

Excess flash 140 is present around the margin of the wing section 100. The excess flash 140 is a natural result of vacuum forming in a mold. The excess flash 140 may be trimmed before assembly of the wing section 100 into a completed wing structure.

### Delta Wing Aircraft Assembly

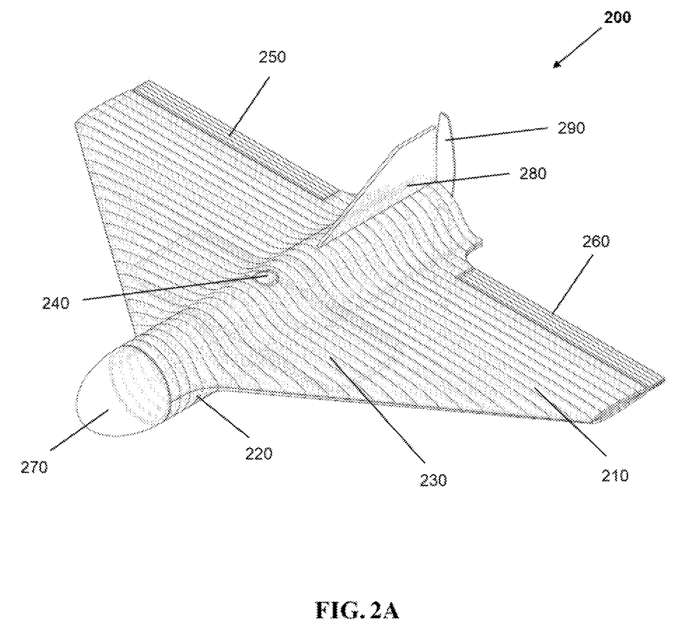

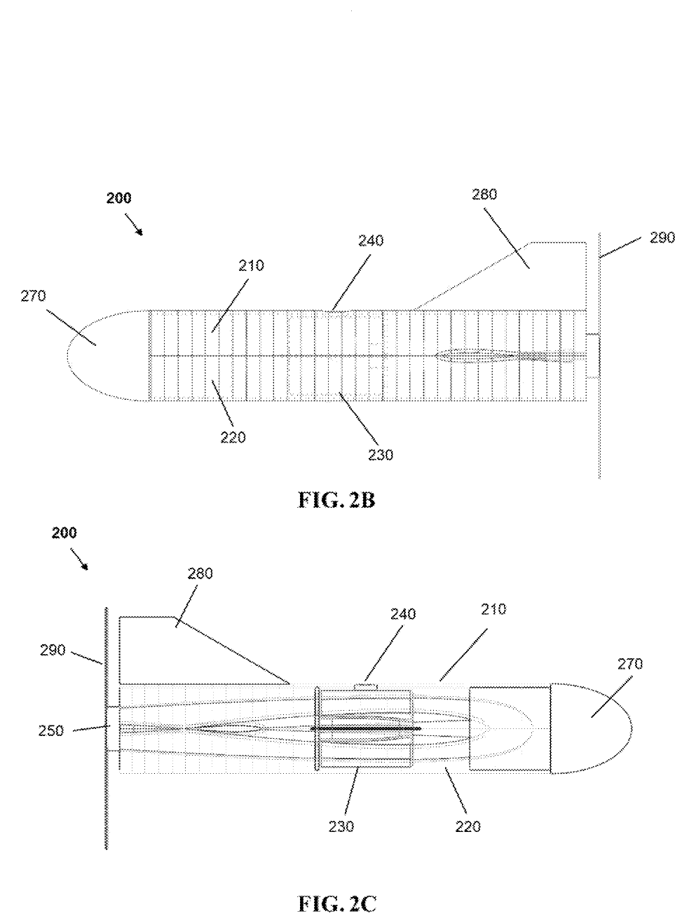

Referring to FIG. 2A, a delta wing aircraft design 200 assembled from thermoformed multiwall material is shown. The delta wing aircraft design 200 comprises a top half 210 and a bottom half 220 that together form the primary airframe structure. The top half 210 may be thermoformed in a vacuum mold and then trimmed. The bottom half 220 may be symmetrical to the top half 210 for economy, or the bottom half 220 may be designed and shaped separately to mate with the top half 210 in assembly. The top half 210 and the bottom half 220 may be bonded together by adhesives, plastic welding, fasteners such as screws or rivets, or a combination of fastening systems.

The delta wing aircraft design 200 includes a fuel tank 230 positioned within the interior cavity formed by the top half 210 and the bottom half 220. The fuel tank 230 may be made from appropriate materials for holding fuel safely and may be fixed in place during assembly. A fuel filler collar 240 is positioned to mate with a corresponding opening in the top half 210 to allow for refueling access.

The delta wing aircraft design 200 includes control surfaces in the form of an elevon 250 and an elevon 260 positioned along the trailing edges of the delta wing configuration. The elevon 250 and the elevon 260 provide pitch and roll control for the delta wing aircraft design 200. In some cases, the elevon 250 and the elevon 260 may be split into multiple segments for performance and maneuverability.

A nose cone 270 is located at the forward portion of the delta wing aircraft design 200. The nose cone 270 may serve as a fairing and may contain a payload. The nose cone 270 may be made from a variety of materials. A vertical fin 280 extends upward from the rear section of the delta wing aircraft design 200 to provide directional stability. The vertical fin 280 may also be made from a variety of materials.

A propeller 290 is positioned at the rear of the delta wing aircraft design 200 for propulsion. The propeller 290 indicates the provision for a propulsion module fixed in the rear of the delta wing aircraft design 200. In some cases, a forward propulsion module may be located in front of the delta wing aircraft design 200, where the nose cone 270 is positioned. The propulsion module may burn fuel stored in the fuel tank 230. In some cases, other propulsion systems may be used, including batteries and electric motors.

The delta wing aircraft design 200 demonstrates the application of thermoformed multiwall components to a complete aircraft structure. In the delta wing configuration, the majority of the aircraft may be made from a minimal number of parts, such as the top half 210 and the bottom half 220 fastened together. Additional parts such as control surfaces, fairings, cowlings, struts, propulsion means, fuel tanks, batteries, antennas, and other components may be accommodated by the design and provided for in the forms of the manufactured parts. Some or all of these additional parts may be made from materials other than multiwall sheets and may be fixed in the assembly by friction, fasteners, adhesives, or plastic welding.

Aircraft components that may be manufactured using the thermoforming methods and multiwall materials disclosed herein include fuselages, wings, tails, empennage, stabilizers, vertical fins, dorsal fins, flaps, ailerons, fairings, and cowlings. The fuselage, wing, and empennage may be made from multiwall sheet formed into aircraft components using thermoforming vacuum mold processes.

Referring to FIGS. 2B-2C, the delta wing aircraft design 200 is shown in side view and internal component configurations. FIG. 2B illustrates a side view of the delta wing aircraft design 200 in an assembled configuration. The delta wing aircraft design 200 comprises a top half 210 and a bottom half 220 that together form the outer shell of the delta wing configuration. The top half 210 and the bottom half 220 may be thermoformed from multiwall thermoplastic material and bonded together to create an enclosed airframe structure.

FIG. 2C illustrates the delta wing aircraft design 200 with internal components visible. The top half 210 and the bottom half 220 define an interior cavity that accommodates various internal components. A fuel tank 230 is positioned within the interior cavity formed by the top half 210 and the bottom half 220. A fuel filler collar 240 is mounted on the top half 210 and mates with a corresponding opening to provide refueling access to the fuel tank 230.

A nose cone 270 and/or payload is attached at the forward end of the delta wing aircraft design 200. A vertical fin 280 extends upward from the rear section of the delta wing aircraft design 200 to provide directional stability. A propeller 290 is mounted at the aft end of the delta wing aircraft design 200 for propulsion. An elevon 250 is positioned at the trailing edge of the delta wing configuration to provide pitch and roll control.

The interior cavity created by the bonded top half 210 and bottom half 220 may accommodate various internal components in addition to the fuel tank 230. In some cases, internal components may include carbon tube spars, structural spars, ribs, stringers, batteries, electronics, motors, actuator arms, wires, connectors, and other components that are not made of multiwall thermoplastic material. In some cases, internal components may be placed and held by adhesives, fasteners, force, friction, or combinations thereof within conformal spaces and features formed into the enclosing thermoplastic structure during thermoforming.

The methods and materials disclosed herein may be applied to products other than aircraft. In some cases, products that may benefit from thermoforming multiwall thermoplastic materials include wheeled ground vehicles, boats, storage cabinets, equipment cabinets, furniture, and launch and recovery equipment for aircraft. In some cases, sports equipment may be manufactured using the methods and materials disclosed herein, including paddle boards, kayaks, wake boards, and surf boards.

### Multiwall Material Structure

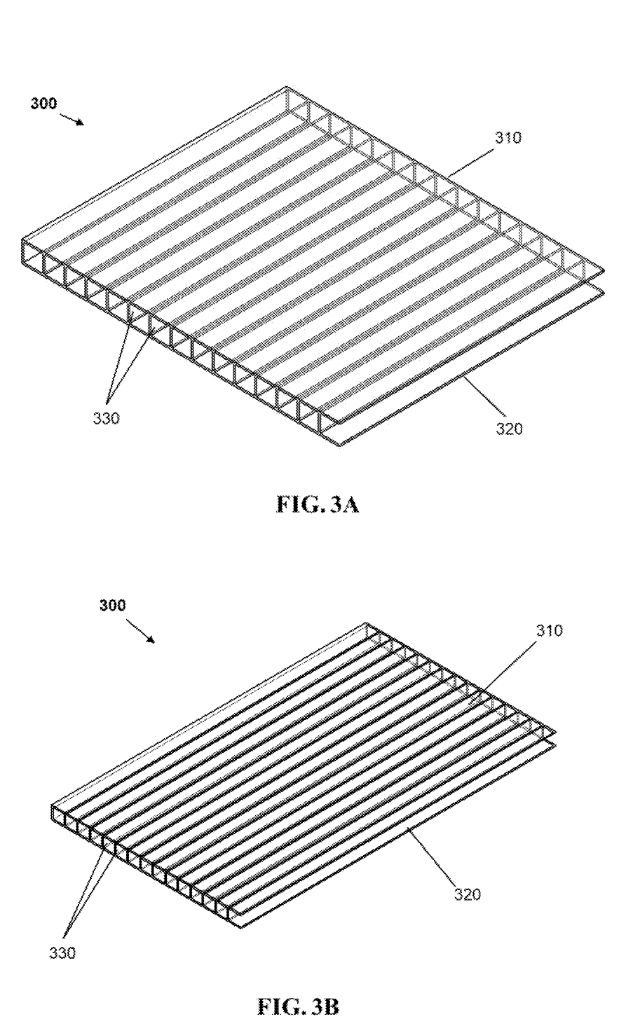

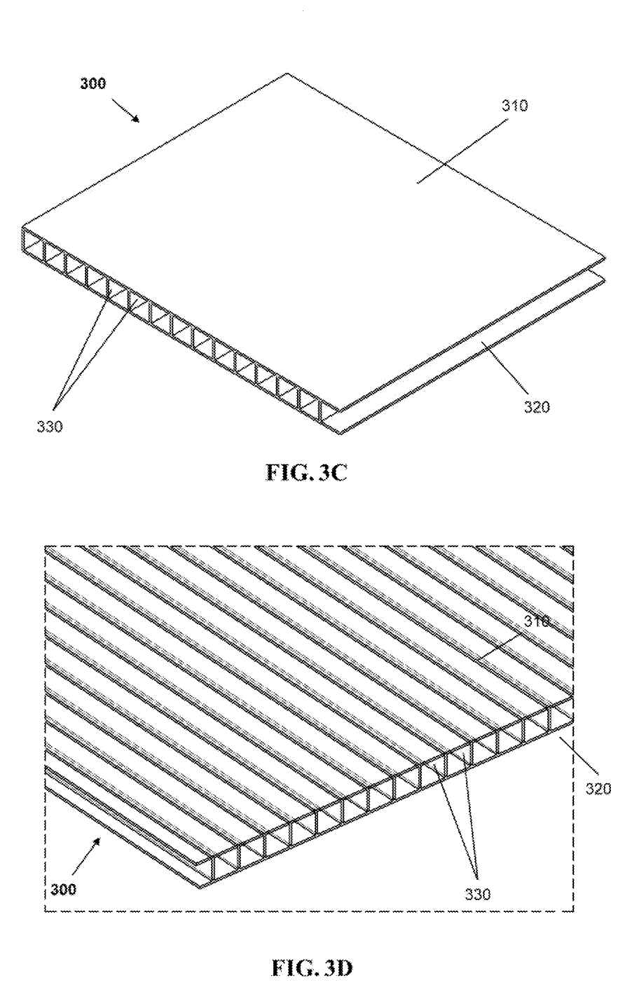

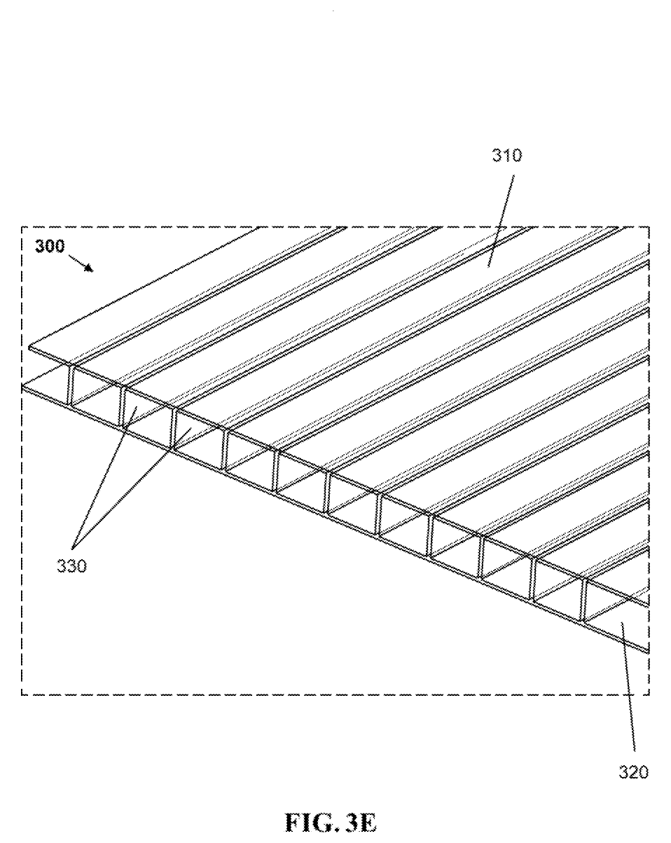

Referring to FIGS. 3A-3B, a multiwalled material 300 is shown with internal structure visible. The multiwalled material 300 comprises a sheet of multiwall thermoplastic material having a first wall with a top surface 310 forming a first planar surface, a second wall with a bottom surface 320 forming a second planar surface spaced apart from the top surface 310, and a plurality of uniformly spaced web walls 330 extending between the first wall and the second wall. The uniformly spaced web walls 330 connect the top surface 310 and the bottom surface 320 to provide structural support and stiffness to the multiwalled material 300. In some cases, the web walls may not be uniformly spaced and may instead be arranged with varying spacing, varying thickness, varying angles, or combinations thereof to achieve desired structural or thermal properties for specific applications.

In some cases, the web walls may be arranged with non-uniform spacing to provide increased structural support in regions of higher stress concentration while reducing material weight in lower stress regions. In some cases, the web walls may have varying thickness across the sheet, with thicker web walls positioned in areas requiring greater load-bearing capacity. In some cases, the web walls may be oriented at varying angles across different portions of the sheet to optimize stiffness characteristics for specific loading conditions. In some cases, a combination of perpendicular and angled web walls may be used within a single sheet to achieve directional stiffness properties tailored to the intended application.

The web walls 330 create channels or flutes within the multiwalled material 300. The web walls 330 run along the length of the multiwalled material 300 between the top surface 310 and the bottom surface 320 in a parallel arrangement. The multiwall configuration of the multiwalled material 300 provides enhanced panel stiffness compared to single-wall materials of equivalent weight. The structural stiffness supplied by the web walls 330 may replace internal support that would otherwise be supplied by foam core or other internal structural support materials.

The multiwalled material 300 may be used as source material for thermoforming processes. In some cases, the multiwalled material 300 may be made of polycarbonate. In some cases, the multiwalled material 300 may be made of polypropylene. In some cases, the multiwalled material 300 may be made of other thermoplastic materials suitable for thermoforming parts with various levels of geometric complexity. The multiwalled material 300 may be formed with uniform thickness of the top surface 310, the bottom surface 320, and the uniformly spaced web walls 330 connecting the top surface 310 and the bottom surface 320.

In some cases, the multiwalled material 300 may comprise more than two planar surfaces, with uniformly spaced web walls 330 formed between adjacent surfaces for structural strength and stability. The uniformly spaced web walls 330 may be perpendicular to the top surface 310 and the bottom surface 320, or the uniformly spaced web walls 330 may connect at an angle. In some cases, the uniformly spaced web walls 330 may be made at slanted angles to tailor the physical properties of the multiwalled material 300. In some cases, the uniformly spaced web walls 330 may be made with alternating slanted angles, each mirroring an adjacent wall, to tailor the physical properties of the multiwalled material 300.

The multiwalled material 300 may be thermoformed to create a structural body for an aircraft component or other product. During thermoforming, the sheet of multiwall thermoplastic material may be transformed from an originally flat configuration into a three-dimensional shape such that the top surface 310 defines a first formed surface and the bottom surface 320 defines a second surface. The uniformly spaced web walls 330 may be stretched during the thermoforming process and may cool to provide structural support between the first wall and the second wall within the shaped component.

Referring to FIGS. 3C-3D, the multiwalled material 300 is shown in additional configurations. FIG. 3C illustrates a schematic isometric view of the multiwalled material 300 shown as opaque. The opaque rendering illustrates the external appearance of the multiwalled material 300 as a solid sheet, with the top surface 310, the bottom surface 320, and the uniformly spaced web walls 330 visible at the exposed edge. In some cases, the multiwalled material 300 may be made of opaque thermoplastic material, or the multiwalled material 300 may be made of translucent or transparent material depending on the application.

FIG. 3D illustrates the multiwalled material 300 as polypropylene. The multiwalled material 300 includes the top surface 310, the bottom surface 320, and the uniformly spaced web walls 330 visible at the exposed edge of the sheet. The polypropylene multiwall sheet material shows the internal web wall channels along the cut edge. In some cases, the multiwall thermoplastic material comprises polypropylene.

Referring to FIG. 3E, the multiwalled material 300 is shown as polycarbonate. The multiwalled material 300 is shown as a transparent sheet structure with the top surface 310 forming the upper planar layer, the bottom surface 320 forming the lower planar layer, and the uniformly spaced web walls 330 extending between the two surfaces. The transparent nature of the polycarbonate material allows visualization of the internal structure, including the uniformly spaced web walls 330 that run longitudinally through the sheet. The uniformly spaced web walls 330 are oriented perpendicular to the top surface 310 and the bottom surface 320, providing structural rigidity while maintaining a lightweight construction. In some cases, the multiwall thermoplastic material comprises polycarbonate. As described above, the multiwall thermoplastic material may comprise at least one of polycarbonate and polypropylene, and in some cases, other thermoplastic materials may be used for thermoforming parts with various levels of geometric complexity.

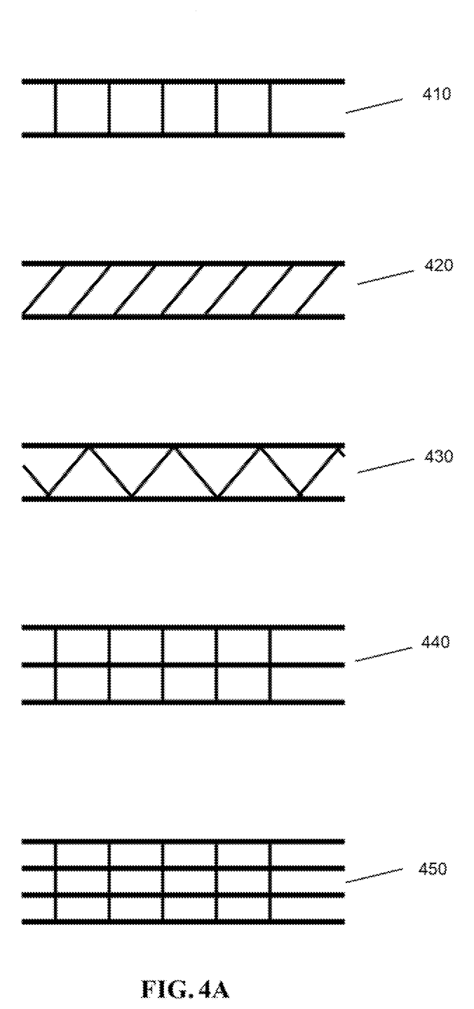

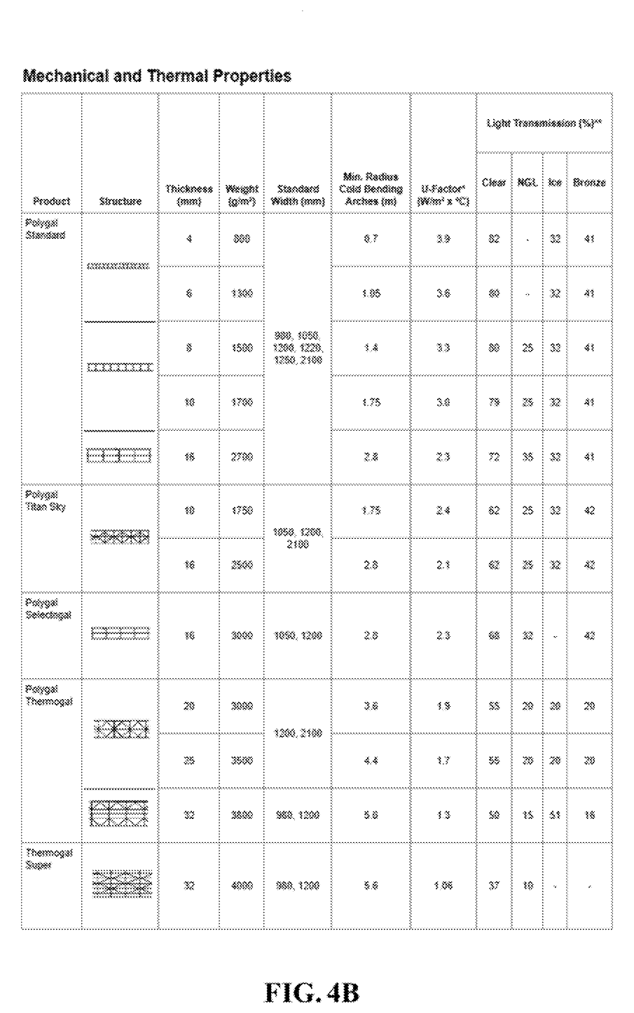

Referring to FIG. 4A, example multiwall profiles showing various web wall configurations are illustrated. The multiwall thermoplastic material may be configured with different web wall arrangements to tailor the physical properties of the multiwall sheet for various applications.

A uniformly spaced web wall 410 profile comprises two parallel horizontal surfaces connected by vertical web walls arranged at regular intervals. The uniformly spaced web wall 410 configuration provides structural support perpendicular to the adjacent planar surfaces.

A uniformly spaced slanted web wall 420 profile comprises two parallel horizontal surfaces connected by diagonal web walls oriented in the same direction. The uniformly spaced slanted web wall 420 configuration connects the adjacent surfaces at an angle rather than perpendicular to the surfaces. In some cases, the slanted angle of the uniformly spaced slanted web wall 420 may be selected to tailor the physical properties of the multiwall sheet for a particular application.

A uniformly spaced truss web wall 430 profile comprises two parallel horizontal surfaces connected by alternating diagonal web walls forming a triangular truss pattern. In the uniformly spaced truss web wall 430 configuration, each web wall mirrors an adjacent web wall, with the alternating slanted angles providing structural properties different from the uniformly spaced web wall 410 or the uniformly spaced slanted web wall 420 configurations.

A three wall design with uniformly spaced web wall 440 comprises three parallel horizontal surfaces with two rows of vertical web walls connecting adjacent surfaces. The three wall design with uniformly spaced web wall 440 provides additional structural strength and stability compared to two-wall configurations.

A four wall design with uniformly spaced web wall 450 comprises four parallel horizontal surfaces with three rows of vertical web walls connecting adjacent surfaces. The four wall design with uniformly spaced web wall 450 may be used for thicker materials. In some cases, multiwall sheet may comprise more than four walls, such as five, six, or seven walls for thicker materials up to 32 millimeters.

The connecting web walls between adjacent surfaces of multiwall sheet material may be made thicker or thinner than the adjacent surfaces. In some cases, the adjacent surfaces may each be made with different thicknesses, with each feature independent from the others. In some cases, multiwall sheet may be made with different materials for each of the planar surfaces, with each of two or more surfaces having a different material, and with a different material for the multiple connecting walls.

In some cases, the multiwall thermoplastic material may be infused with substances that strengthen the material. The substances may comprise chemical additives or physical additives. In some cases, the physical additives may comprise fibers. In some cases, the physical additives may comprise carbon fibers.

Referring to FIG. 4B, a table of mechanical and thermal properties for multiwall polycarbonate profiles is shown. The table illustrates the relationship between material thickness, weight, bending radius, thermal insulation properties, and light transmission across different product configurations.

Multiwall polycarbonate sheets may be available in thicknesses ranging from 4 millimeters to 32 millimeters. The weight of the multiwall sheet may increase with thickness, ranging from approximately 800 grams per square meter for 4 millimeter thick material to approximately 4000 grams per square meter for 32 millimeter thick material with complex internal structures.

The minimum bending radius for cold bending arches may increase with material thickness. In some cases, a 4 millimeter thick multiwall sheet may have a minimum cold bending radius of approximately 0.7 meters, while a 32 millimeter thick multiwall sheet may have a minimum cold bending radius of approximately 5.6 meters. The minimum bending radius may be relevant for applications where the multiwall sheet is to be curved without heating.

The U-factor, which indicates thermal insulation performance measured in watts per square meter times degrees Celsius, may decrease as material thickness increases. In some cases, a 4 millimeter thick multiwall sheet may have a U-factor of approximately 3.9, while thicker materials with more complex internal structures may have U-factors as low as approximately 1.06 for 32 millimeter thick material. Lower U-factor values indicate greater thermal insulation.

Light transmission through multiwall polycarbonate sheets may vary based on thickness and material color. In some cases, clear 4 millimeter thick multiwall sheet may transmit approximately 82 percent of light, while thicker materials may transmit less light. A 32 millimeter thick multiwall sheet with complex internal structure may transmit approximately 37 percent of light in clear configurations. Light transmission may also vary for tinted materials such as bronze or ice-colored variants.

Different product configurations may provide different combinations of properties. In some cases, multiwall sheets with X-pattern internal structures may provide different thermal and optical properties compared to sheets with parallel vertical web walls. In some cases, three-wall or four-wall configurations may provide different structural and thermal characteristics compared to two-wall configurations of similar thickness.

During thermoforming, the multiwall sheet may be formed into a final profile shape that is thinner, thicker, or the same thickness as the original sheet. The thermoforming process may stretch or compress the multiwall material depending on the geometry of the mold surfaces and the degree of deformation applied to the heated sheet.

### Thermoforming Process

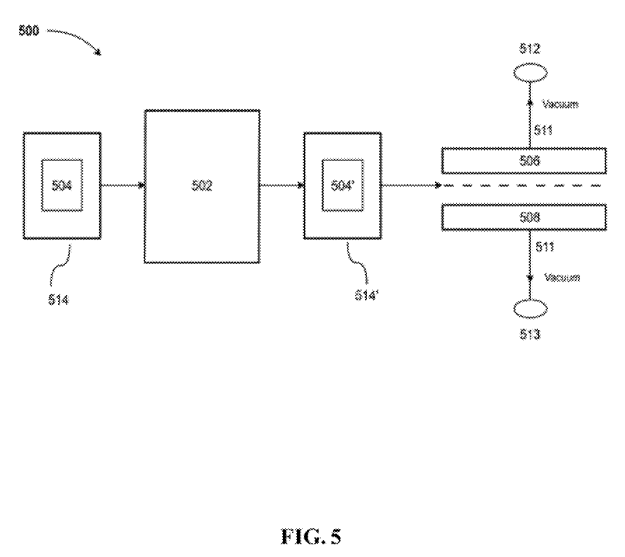

Referring to FIG. 5, a thermoforming process 500 for forming multiwall sheets into shaped components is shown. The thermoforming process 500 illustrates the steps for heating and forming a sheet of multiwall thermoplastic material using a vacuum mold.

A trimmed multiwall sheet 504 is secured in a frame 514 prior to heating. The frame 514 may comprise an open rectangular frame that supports the edges of the trimmed multiwall sheet 504 during handling and forming. In some cases, the trimmed multiwall sheet 504 may be secured to the frame 514 using clips or other fastening means.

The frame 514 with the trimmed multiwall sheet 504 is transferred into an oven 502 where the trimmed multiwall sheet 504 is heated until the multiwall thermoplastic material becomes pliable. The thermoforming temperature for polycarbonate multiwall sheet may be approximately 375 degrees Fahrenheit. After heating, the trimmed multiwall sheet 504 becomes a heated multiwall sheet 504' held in a frame 514'.

The frame 514' with the heated multiwall sheet 504' may be transferred from the oven 502 into the mold.

The heated multiwall sheet 504' is positioned between an outer mold 506 and an inner mold 508 of a vacuum mold. The outer mold 506 defines a first mold surface and the inner mold 508 defines a second mold surface. The heated multiwall sheet 504' in the frame 514' is transferred from the oven 502 to the mold and the mold is closed within approximately five seconds before the material cools below thermoforming temperature.

A vacuum 511 is applied through a vacuum port 512 connected to the outer mold 506 and through a vacuum port 513 connected to the inner mold 508. In some cases, the vacuum 511 is turned on before the heated multiwall sheet 504' is inserted into the mold to ensure immediate forming upon mold closure. The vacuum mold is closed to compress the heated multiwall sheet 504' between the outer mold 506 and the inner mold 508.

Vacuum suction is applied to both the outer mold 506 and the inner mold 508 simultaneously to draw a first planar surface of the heated multiwall sheet 504' against the first mold surface of the outer mold 506 and a second planar surface of the heated multiwall sheet 504' against the second mold surface of the inner mold 508, thereby forming a shaped component. The dual-mold arrangement allows both surfaces of the multiwall sheet to be shaped simultaneously, with the outer mold 506 forming an exterior surface and the inner mold 508 forming an interior surface of the shaped component.

After forming, the shaped component is allowed to cool within the vacuum mold. The shaped component is then removed from the vacuum mold. In some cases, the shaped component may have excess material around the margins that is trimmed before assembly.

In other embodiments, the multiwall thermoplastic material may be thermoformed using only a single mold rather than the dual-mold arrangement described above. In such cases, the heated multiwall sheet may be drawn against the single mold surface by vacuum suction, with the unmolded side of the sheet remaining uncontrolled during the forming process. The unmolded surface may deform in response to the stretching and shaping of the molded surface, but the final geometry of the unmolded side would not be precisely defined by a mold surface. This single-mold approach may be suitable for applications where only one surface of the shaped component requires precise dimensional control, while the opposite surface may have less critical tolerances.

### Method for Making Shaped Component Parts

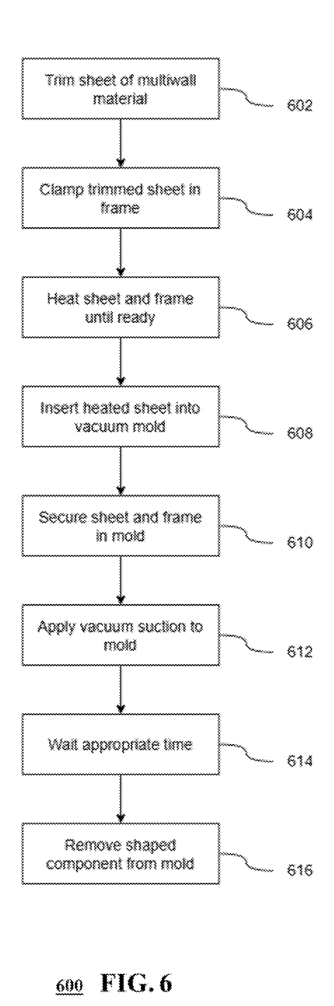

Referring to FIG. 6, a method 600 for making shaped component parts from multiwall thermoplastic material using a vacuum thermoforming process is shown. The method 600 comprises a series of steps for transforming a sheet of multiwall thermoplastic material into a shaped component.

At a step 602, a sheet of multiwall material is trimmed to an appropriate size. The sheet of multiwall material may be trimmed to fit an open rectangular frame that will support the sheet during subsequent processing steps.

At a step 604, the trimmed sheet is clamped in a frame. The frame may comprise an open rectangular frame that supports the edges of the trimmed sheet during handling and forming. The frame supports the multiwall sheet while the multiwall sheet is moved from an oven to a mold.

At a step 606, the sheet and frame are heated until the multiwall thermoplastic material is ready for forming. The frame with the trimmed sheet may be placed into an oven and heated until the multiwall thermoplastic material softens and becomes pliable.

At a step 608, the heated sheet is inserted into a vacuum mold. The frame with the heated sheet may be transferred from the oven and positioned between two mold halves of the vacuum mold.

At a step 610, the sheet and frame are secured in the mold. The vacuum mold may be closed to compress the heated sheet between the mold halves. In some cases, mechanical guides may be used to orient the frame precisely within the mold.

At a step 612, vacuum suction is applied to the mold to draw the heated multiwall thermoplastic material against the mold surfaces. The vacuum suction may be applied to both mold halves simultaneously to form both surfaces of the multiwall sheet, thereby creating a shaped component.

At a step 614, an appropriate time is allowed for the shaped component to cool and retain the formed shape. The multiwall thermoplastic material cools within the vacuum mold and solidifies in the three-dimensional configuration defined by the mold surfaces.

The cooling time may vary depending on the thickness of the multiwall material, the complexity of the formed shape, and the ambient temperature conditions. In some cases, the cooling time may be approximately tens of seconds. Thicker multiwall materials or components with deeper draws may require longer cooling times to ensure dimensional stability. The internal web walls of the multiwall thermoplastic material cool and solidify during this period, providing structural support between the first wall and the second wall in the formed configuration.

At a step 616, the shaped component is removed from the vacuum mold. The shaped component may have excess material around the margins that is trimmed before assembly into a finished product.

In some cases, the cycle time for the method 600 may be approximately six minutes or less.

### Vacuum Mold Configuration

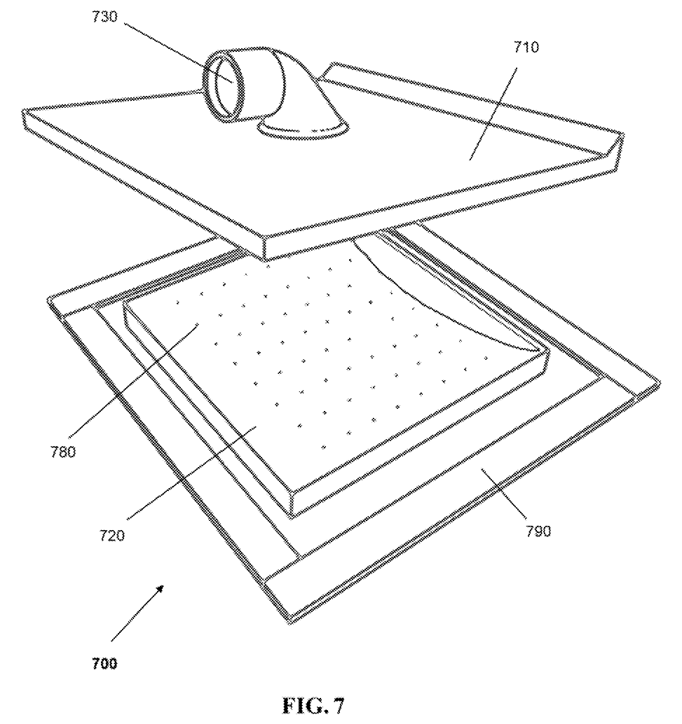

Referring to FIG. 7, a vacuum mold for wing 700 is shown in an exploded view. The vacuum mold for wing 700 is configured for forming a top half of a wing, such as the wing section 100 shown in FIG. 1. The vacuum mold for wing 700 comprises a top half 710 and a bottom half 720 shown in a separated configuration.

The top half 710 includes a vacuum port 730 extending from an upper surface of the top half 710. The vacuum port 730 connects to a vacuum source for applying vacuum pressure during the thermoforming process. The vacuum port 730 distributes vacuum suction across the mold surface of the top half 710 to draw the heated multiwall sheet against the mold surface.

The bottom half 720 features pilot holes 780 distributed across a mold surface of the bottom half 720. The pilot holes 780 distribute vacuum pressure evenly across the multiwall sheet during forming. In some cases, the top half 710 may also include pilot holes distributed across the mold surface of the top half 710 for vacuum distribution.

A frame 790 surrounds the bottom half 720 and provides a mounting structure for securing and positioning the multiwall sheet material during the thermoforming process. The frame 790 may comprise an open rectangular frame that supports the edges of the multiwall sheet during handling and forming. In some cases, the vacuum mold for wing 700 may include mating channels configured to receive the frame 790 to ensure precise orientation of the heated sheet during forming. The mating channels may be formed in the top half 710, the bottom half 720, or both mold halves.

The top half 710 and the bottom half 720 may be coupled by a pivotable coupling. In some cases, the bottom half 720 may be hinged at a lower edge while the top half 710 remains stationary. In some cases, the top half 710 may be hinged while the bottom half 720 remains stationary. In some cases, both the top half 710 and the bottom half 720 may be movable relative to each other. The pivotable coupling allows the vacuum mold for wing 700 to open and close to receive the heated multiwall sheet and compress the heated multiwall sheet between the top half 710 and the bottom half 720 during forming.

The vacuum mold for wing 700 may be made from various materials such as plastic, MDF, and metal.

### Vacuum Mold Open and Closed Configuration

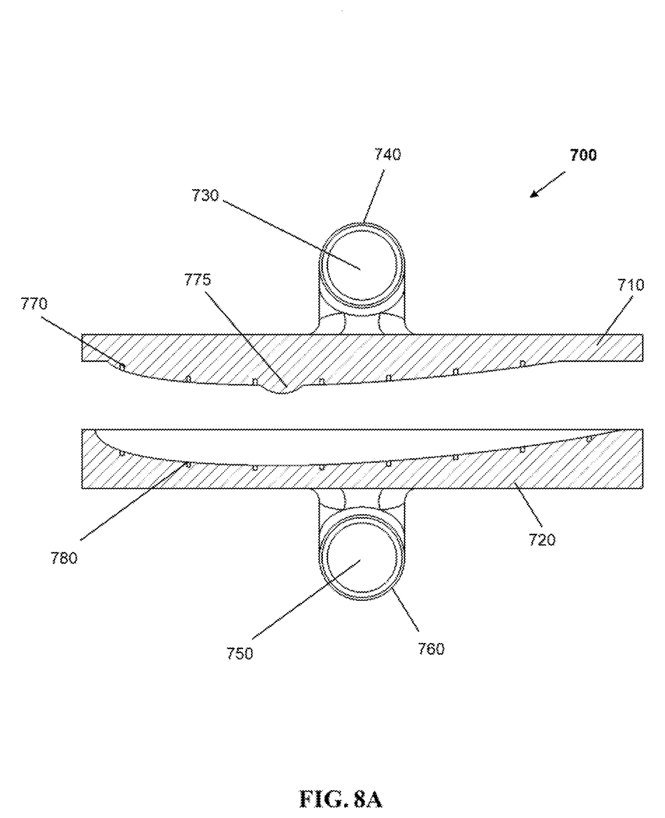

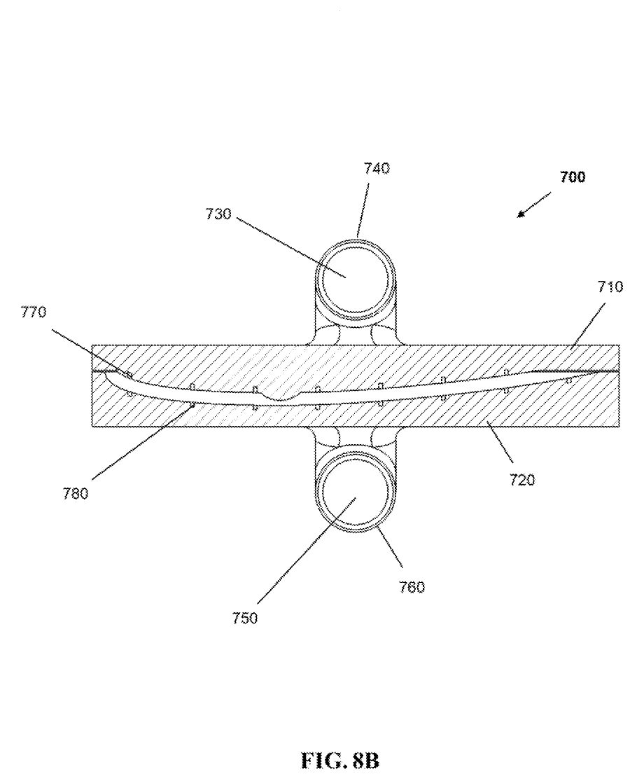

Referring to FIG. 8A, a cross-sectional view of the vacuum mold for wing 700 in an open configuration is shown. The vacuum mold for wing 700 comprises a top half 710 and a bottom half 720 shown in a separated configuration prior to forming.

The top half 710 includes a vacuum fixture 740 connected to a vacuum port 730. The vacuum fixture 740 provides a mounting structure for connecting the vacuum port 730 to a vacuum source. The vacuum port 730 distributes vacuum suction across the mold surface of the top half 710 during the thermoforming process. A plurality of pilot holes 770 are distributed along the mold surface of the top half 710. The pilot holes 770 distribute vacuum pressure evenly across the multiwall sheet during forming by providing multiple points of suction across the mold surface.

A protruding channel to form a spar recess 775 extends from an inner mold surface of the top half 710. The protruding channel to form a spar recess 775 is configured to create a corresponding channel in the thermoformed part for receiving an internal aircraft component. In some cases, the internal aircraft component comprises a structural support. In some cases, the structural support comprises a spar. The protruding channel to form a spar recess 775 may be configured to form at least one of: a slot for receiving a wing spar or wing rib, a planar mounting surface for internal equipment, and a non-planar recess for indexing or mounting equipment.

The bottom half 720 includes a vacuum fixture 760 connected to a vacuum port 750. The vacuum fixture 760 provides a mounting structure for connecting the vacuum port 750 to a vacuum source. A plurality of pilot holes 780 are distributed along the mold surface of the bottom half 720. The pilot holes 780 distribute vacuum pressure evenly across the multiwall sheet during forming.

A shape of the mold surface of the top half 710 may be different from a shape of the mold surface of the bottom half 720. In some cases, the mold surface of the bottom half 720 may be a smooth, uniform surface, and the mold surface of the top half 710 may comprise at least one recess configured to form a corresponding channel in the shaped component for receiving an internal aircraft component. The protruding channel to form a spar recess 775 on the top half 710 creates a recess in the formed part that accommodates structural elements such as spars during assembly.

Referring to FIG. 8B, a cross-sectional view of the vacuum mold for wing 700 in a closed configuration is shown. The vacuum mold for wing 700 comprises a top half 710 and a bottom half 720 positioned together to form a closed mold cavity. A sheet of multiwall thermoplastic material is compressed between the top half 710 and the bottom half 720 in the closed configuration.

The top half 710 includes a vacuum fixture 740 connected to a vacuum port 730. A plurality of pilot holes 770 are distributed across the mold surface of the top half 710 to distribute vacuum pressure evenly during forming. The bottom half 720 includes a vacuum fixture 760 connected to a vacuum port 750. A plurality of pilot holes 780 are distributed across the mold surface of the bottom half 720 to distribute vacuum pressure evenly during forming.

In the closed configuration, vacuum suction may be applied simultaneously through the vacuum port 730 via the vacuum fixture 740 and through the vacuum port 750 via the vacuum fixture 760. The simultaneous application of vacuum suction to both the top half 710 and the bottom half 720 draws both planar surfaces of the multiwall thermoplastic sheet against the respective mold surfaces. The vacuum suction draws a first planar surface of the multiwall thermoplastic sheet against the mold surface of the bottom half 720 and draws a second planar surface of the multiwall thermoplastic sheet against the mold surface of the top half 710.

The sheet of multiwall thermoplastic material is transformed from an originally flat configuration into a three-dimensional shape by thermoforming such that the first planar surface defines a first formed surface and the second planar surface defines a second surface. The dual-mold arrangement of the vacuum mold for wing 700 allows both surfaces of the multiwall thermoplastic sheet to be shaped simultaneously, with the bottom half 720 forming an exterior surface and the top half 710 forming an interior surface of the shaped component. In some cases, the vacuum may be turned on before the heated multiwall sheet is inserted into the vacuum mold for wing 700 to ensure immediate forming upon mold closure.

### Wing Assembly from Two Portions

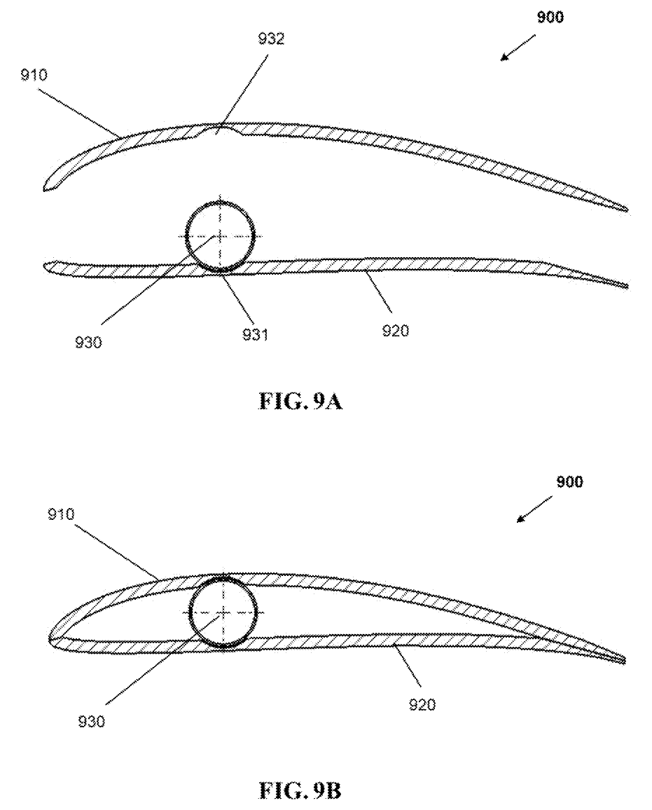

Referring to FIGS. 9A-9B, a wing 900 assembled from separate wing portions is shown. FIG. 9A illustrates an upper wing portion 910 and a lower wing portion 920 shown separated prior to assembly. The upper wing portion 910 and the lower wing portion 920 may each be thermoformed from multiwall thermoplastic material as described above. A spar recess 932 is formed into an interior surface of the upper wing portion 910 during the thermoforming process. A spar recess 931 is formed into an interior surface of the lower wing portion 920 during the thermoforming process. The spar recess 932 and the spar recess 931 are configured to accommodate a spar 930. In some cases, spar recesses may be formed in both the upper wing portion 910 and the lower wing portion 920. In some cases, a spar recess may be formed in only one of the upper wing portion 910 or the lower wing portion 920. The spar recess 932 and the spar recess 931 may each comprise a slot configured to receive at least one of a wing spar and a wing rib.

The spar 930 may comprise various materials and configurations. In some cases, the spar 930 may comprise a carbon tube. In some cases, the spar 930 may comprise machined G10/FR4 fiberglass plate. In some cases, the spar 930 may comprise carbon plate. In some cases, the spar 930 may comprise wood or plywood. In some cases, the spar 930 may comprise various shear webs with pultruded composite caps. The spar 930 is shown in circular cross-section positioned between the upper wing portion 910 and the lower wing portion 920.

In some cases, the spar 930 may have a rectangular cross-section. In some cases, the spar 930 may have a square cross-section. In some cases, the spar 930 may have an I-beam cross-section. In some cases, the spar 930 may have a C-channel cross-section. In some cases, the spar 930 may have an oval or elliptical cross-section. In some cases, the spar 930 may have a hollow rectangular tube cross-section. The spar recess 932 may be configured with a corresponding shape to accommodate the cross-sectional profile of the spar 930.

FIG. 9B illustrates the wing 900 in an assembled configuration with the spar 930. The upper wing portion 910 and the lower wing portion 920 have been joined together with the spar 930 secured between the wing portions within the spar recesses. The wing 900 demonstrates how thermoformed multiwall wing portions may be bonded together around the spar 930 to form a complete wing structure.

To assemble the wing 900, the upper wing portion 910 and the lower wing portion 920 may each be formed by thermoforming, and the upper wing portion 910 may be bonded to the lower wing portion 920 to form an assembled structure. The spar 930 may be positioned between the upper wing portion 910 and the lower wing portion 920 prior to bonding, wherein the spar 930 is received within channels formed in the upper wing portion 910 and the lower wing portion 920.

Bonding the upper wing portion 910 and the lower wing portion 920 may include running a bead of adhesive around a full perimeter of the wing 900. Adhesive may be applied into the spar recesses of both the upper wing portion 910 and the lower wing portion 920. In some cases, an air-actuated glue gun may be used to apply the adhesive. After the adhesive cures, the edges of the assembled wing 900 may be trimmed.

### Wing Assembly Method

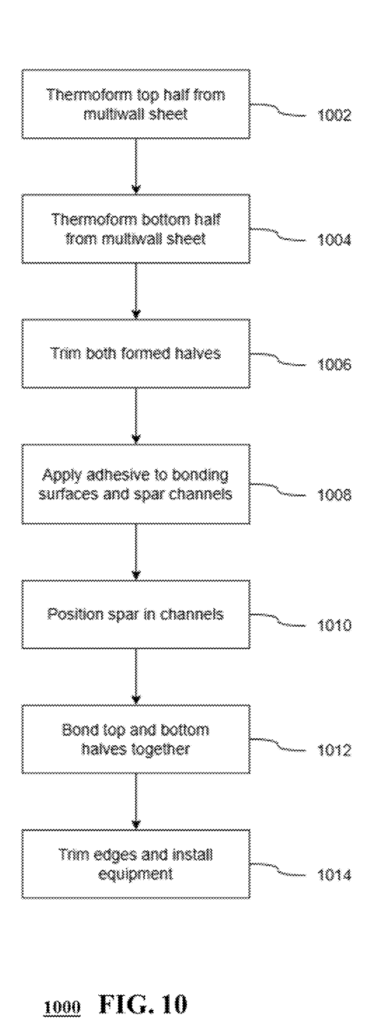

Referring to FIG. 10, a method 1000 for assembling a wing from two separately thermoformed multiwall sheet halves is shown. The method 1000 comprises a series of steps for forming, preparing, and bonding wing portions to create a complete wing structure.

At a step 1002, a top half is thermoformed from a multiwall sheet. The top half may be thermoformed using the vacuum thermoforming process described above with reference to FIGS. 5-8B. The top half may include spar recesses formed into an interior surface during the thermoforming process.

At a step 1004, a bottom half is thermoformed from a multiwall sheet. The bottom half may be thermoformed using the same vacuum thermoforming process as the top half. In some cases, the bottom half may be symmetrical to the top half. In some cases, the bottom half may be designed and shaped separately to mate with the top half in assembly. In some cases, the bottom half may also include spar recesses formed into an interior surface during the thermoforming process. The spar recesses in the bottom half may be configured to mate with corresponding spar recesses in the top half to fully enclose and secure the spar within the assembled wing structure.

At a step 1006, both formed halves are trimmed. The trimming removes excess flash material around the margins of the thermoformed parts. In some cases, the trimming may be performed using manual cutting tools. In some cases, the trimming may be performed using automated cutting equipment.

At a step 1008, adhesive is applied to bonding surfaces and spar channels. The adhesive may be applied around a full perimeter of the wing where the top half and the bottom half will meet. The adhesive may also be applied into the spar channels formed in both the top half and the bottom half. In some cases, an air-actuated glue gun may be used to apply the adhesive.

At a step 1010, a spar is positioned in the channels. The spar may be placed into the spar channels formed in the top half and the bottom half. The spar may comprise various materials including carbon tube, machined G10/FR4 fiberglass plate, carbon plate, wood, plywood, or various shear webs with pultruded composite caps.

At a step 1012, the top and bottom halves are bonded together. The top half and the bottom half are brought together with the spar secured between the wing portions within the spar channels. The adhesive applied at the step 1008 bonds the top half to the bottom half and secures the spar within the spar channels. The adhesive may be allowed to cure to complete the bonding.

At a step 1014, edges are trimmed and equipment is installed. After the adhesive cures, a CNC trim of the edges and hatch cutouts may be performed. The CNC trimming provides precise edge finishing and creates openings for access hatches and equipment mounting. After trimming, equipment such as autopilot systems, batteries, payloads, servos, and other components may be fastened or attached into place with the assembled wing structure.

### Single-Piece Foldable Wing Construction

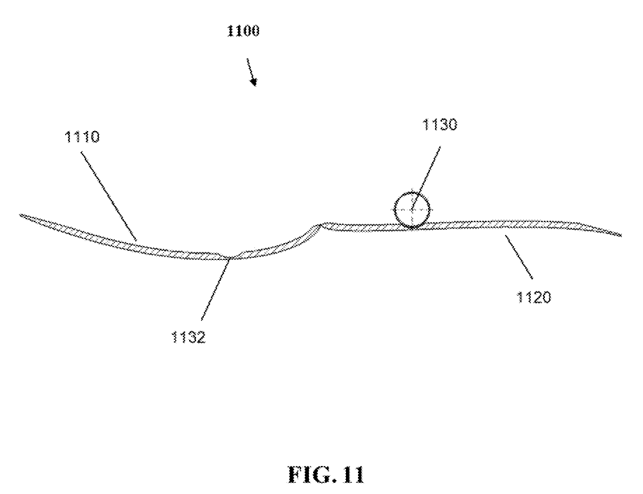

Referring to FIG. 11, an unassembled wing portion 1100 formed with a flattened contiguous profile is shown. The unassembled wing portion 1100 comprises an upper wing portion 1110 and a lower wing portion 1120 that are connected at what will become the leading edge of the wing when assembled. Both the upper wing portion 1110 and the lower wing portion 1120 are formed from multiwall thermoplastic material in a single thermoforming operation using the vacuum thermoforming process described above with reference to FIGS. 5-8B.

The unassembled wing portion 1100 comprises a wing skin having an upper surface portion and a lower surface portion formed as a single contiguous piece. The upper wing portion 1110 corresponds to the upper surface portion of the wing skin, and the lower wing portion 1120 corresponds to the lower surface portion of the wing skin. The single-piece construction of the unassembled wing portion 1100 provides a continuous material connection at the leading edge location.

A spar 1130 is shown in circular cross-section positioned to fit within spar recesses 1132 formed into interior surfaces of the upper wing portion 1110 and the lower wing portion 1120. The spar recesses 1132 are formed during the thermoforming process and are configured to accommodate the spar 1130 when the unassembled wing portion 1100 is folded and assembled. In some cases, the spar 1130 may comprise various materials including carbon tube, machined G10/FR4 fiberglass plate, carbon plate, wood, plywood, or various shear webs with pultruded composite caps. In some cases, the spar recesses 1132 may be configured with shapes corresponding to the cross-sectional profile of the spar 1130.

The unassembled wing portion 1100 is designed to be folded along the leading edge, bringing the upper wing portion 1110 and the lower wing portion 1120 together around the spar 1130. Folding the wing skin about the leading edge brings the upper surface portion and the lower surface portion into opposition. The folding operation positions the spar recesses 1132 of the upper wing portion 1110 and the lower wing portion 1120 in alignment to receive and secure the spar 1130.

After folding, the upper surface portion is bonded to the lower surface portion along a trailing edge to form a wing. The spar 1130 may be bonded within the spar recesses 1132 of both the upper wing portion 1110 and the lower wing portion 1120. In some cases, adhesive may be applied to the spar recesses 1132 and along the trailing edge where the upper wing portion 1110 and the lower wing portion 1120 meet. In some cases, the bonding may be performed using plastic welding.

The single-piece folded wing construction may provide manufacturing advantages compared to assembling separate top and bottom wing halves. The leading edge formed by folding may provide a clean, continuous surface at the leading edge location without requiring precise alignment of separate components at the leading edge. In some cases, the folded wing construction may reduce the amount of adhesive bonding compared to wings assembled from two separate thermoformed halves, as adhesive may be applied at the spar recesses 1132 and along the trailing edge rather than around the full perimeter of the wing.

In some cases, the unassembled wing portion 1100 may include additional features formed during the thermoforming process. In some cases, features for internal fuel tanks, ailerons, flaps, speed brakes, and other control surfaces may be included in the thermoformed part. In some cases, such features may be attached or embedded after the folding and bonding steps.

### Method for Folded Wing Construction

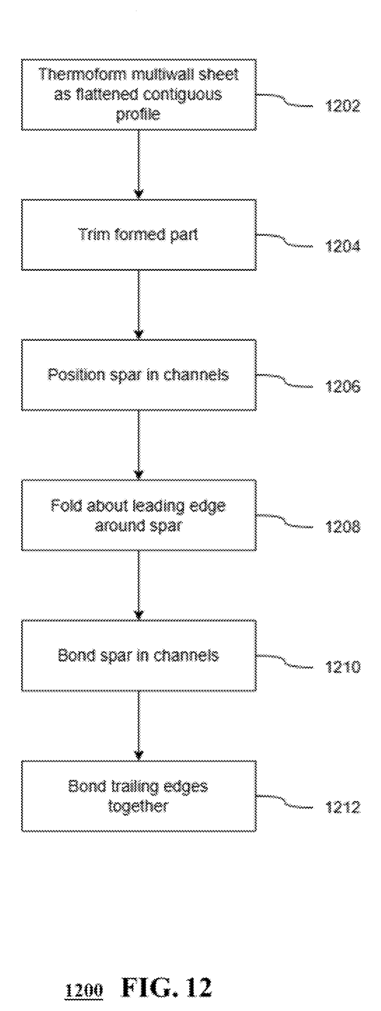

Referring to FIG. 12, a method 1200 for making a wing from a single thermoformed multiwall sheet by folding is shown. The method 1200 comprises a series of steps for forming, trimming, and assembling a wing from a single piece of multiwall thermoplastic material that is folded to create a complete wing structure.

At a step 1202, a multiwall sheet is thermoformed as a flattened contiguous profile. The multiwall sheet may be thermoformed using the vacuum thermoforming process described above with reference to FIGS. 5-8B. The thermoforming process forms both an upper surface portion and a lower surface portion of the wing from a single continuous sheet of multiwall thermoplastic material. The resulting flattened contiguous profile includes spar channels formed into interior surfaces of both the upper surface portion and the lower surface portion during the thermoforming process. The upper surface portion and the lower surface portion remain connected at a location that will become the leading edge of the wing when assembled.

At a step 1204, the formed part is trimmed. The trimming removes excess flash material around the margins of the thermoformed part. In some cases, the trimming may be performed using manual cutting tools. In some cases, the trimming may be performed using automated cutting equipment.

At a step 1206, a spar is positioned in channels formed during thermoforming. The spar may be placed into the spar channels formed in the upper surface portion and the lower surface portion of the flattened contiguous profile. The spar channels are configured to receive and locate the spar when the wing is folded and assembled. In some cases, the spar may comprise various materials including carbon tube, machined G10/FR4 fiberglass plate, carbon plate, wood, plywood, or various shear webs with pultruded composite caps. In some cases, the spar may be made of materials other than thermoformed plastic material.

At a step 1208, the part is folded about a leading edge around the spar. The flattened contiguous profile is mechanically folded along the leading edge location, bringing the upper surface portion and the lower surface portion into opposition around the spar. The folding operation positions the spar channels of the upper surface portion and the lower surface portion in alignment with the spar positioned between the wing portions. The leading edge formed by folding provides a continuous material connection at the leading edge location.

At a step 1210, the spar is bonded in the channels. Adhesive may be applied to the spar channels to secure the spar within the channels of both the upper surface portion and the lower surface portion. In some cases, the bonding may be performed using plastic welding. The spar bonded within the spar channels provides structural support to the assembled wing.

At a step 1212, the trailing edges are bonded together to complete the wing structure. The upper surface portion and the lower surface portion are bonded along the trailing edge where the two portions meet. In some cases, adhesive may be applied along the trailing edge to bond the upper surface portion to the lower surface portion. In some cases, the bonding may be performed using plastic welding. The bonding at the trailing edge completes the enclosed wing structure.

The method 1200 for making a wing from a single thermoformed multiwall sheet by folding may provide manufacturing advantages compared to assembling separate top and bottom wing halves. The leading edge formed by folding may provide a clean, continuous surface at the leading edge location without requiring precise alignment of separate components at the leading edge. In some cases, the method 1200 may reduce the amount of adhesive bonding compared to wings assembled from two separate thermoformed halves, as adhesive may be applied at the spar channels and along the trailing edge rather than around the full perimeter of the wing.

### Fuselage Construction

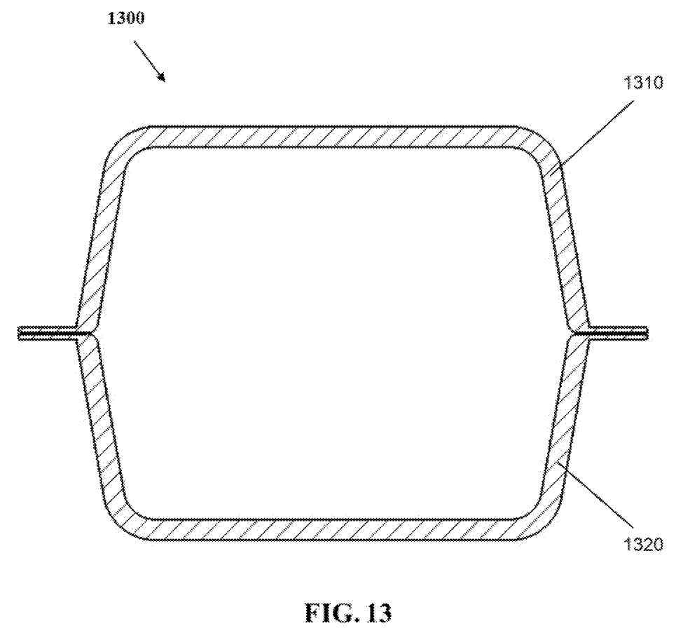

Referring to FIG. 13, a cross section of fuselage 1300 is shown with two halves joined together. The cross section of fuselage 1300 has a generally rectangular shape with rounded corners and is assembled from two separate thermoformed components. A top half 1310 forms the upper portion of the cross section of fuselage 1300 and is thermoformed from multiwall thermoplastic material as described above. A bottom half 1320 forms the lower portion of the cross section of fuselage 1300 and is similarly thermoformed from multiwall thermoplastic material.

The top half 1310 and the bottom half 1320 are joined together along lateral edges of the top half 1310 and the bottom half 1320 to create a continuous enclosed structure. The junction between the top half 1310 and the bottom half 1320 may include bonding flanges or structural features at the joint locations. In some cases, the top half 1310 and the bottom half 1320 may be bonded together using adhesives. In some cases, the top half 1310 and the bottom half 1320 may be bonded together using plastic welding. In some cases, the top half 1310 and the bottom half 1320 may be joined using fasteners such as screws or rivets, or a combination of fastening systems.

The interior of the cross section of fuselage 1300 provides an open cavity for housing internal components. As described above with reference to FIGS. 2A-2C, the interior cavity created by bonded fuselage halves may accommodate various internal components. In some cases, interior surfaces of the top half 1310 and the bottom half 1320 may comprise at least one mounting feature configured for receiving an internal component. In some cases, the at least one mounting feature may comprise at least one of a planar mounting surface and a non-planar recess. The mounting features may be formed into the interior surfaces of the top half 1310 and the bottom half 1320 during the thermoforming process.

In some cases, the internal component may comprise at least one of a battery, a flight controller, a mission payload, a radio, a servo, a motor mount, and a fuel tank. In some cases, internal components may include structural spars, ribs, stringers, electronics, motors, actuator arms, wires, and connectors. The internal components may be placed and held by adhesives, fasteners, force, friction, or combinations thereof within conformal spaces and features formed into the top half 1310 and the bottom half 1320 during thermoforming.

The fuselage construction using two thermoformed multiwall halves may be applied to various aircraft configurations. In some cases, the cross section of fuselage 1300 may be used in aircraft designs comprising a fuselage with wings and empennage. In some cases, the cross section of fuselage 1300 may be used in delta wing or flying wing configurations where the fuselage is integrated with the wing structure.

### Method for Product Assembly from Two Components

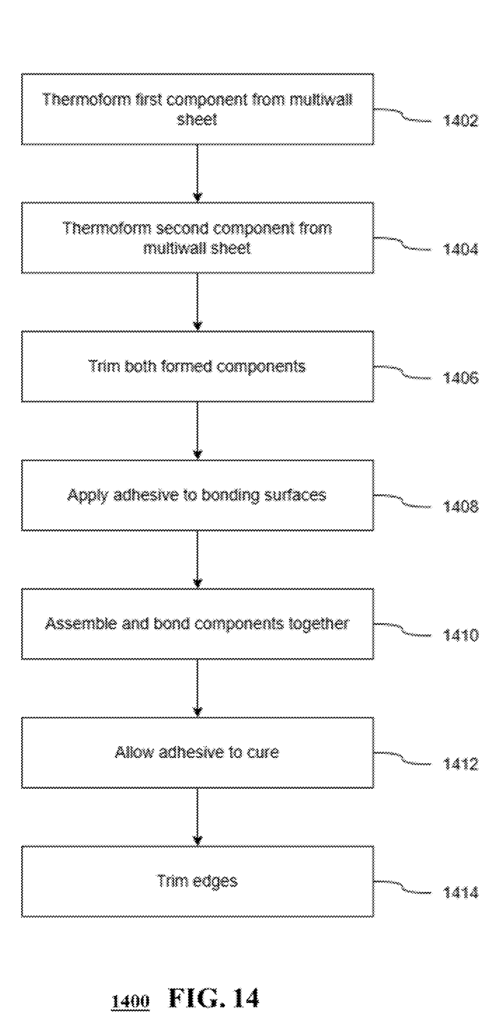

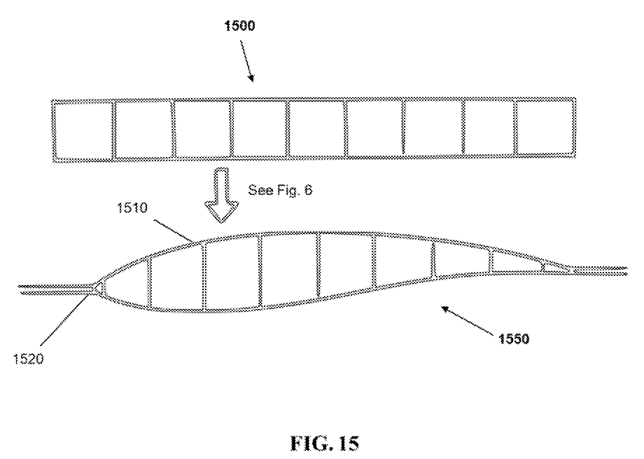

Referring to FIG. 14, a method 1400 for assembling a product from two separately thermoformed multiwall sheet components is shown. The method 1400 comprises a series of steps for forming, preparing, and bonding thermoformed components to create an assembled product such as a fuselage or other structure.

At a step 1402, a first component is thermoformed from a multiwall sheet. The first component may be thermoformed using the vacuum thermoforming process described above with reference to FIGS. 5-8B. The first component may comprise a top half, a left half, or another portion of the product to be assembled. In some cases, the first component may include mounting features or recesses formed into interior surfaces during the thermoforming process.

At a step 1404, a second component is thermoformed from a multiwall sheet. The second component may be thermoformed using the same vacuum thermoforming process as the first component. In some cases, the second component may be symmetrical to the first component. In some cases, the second component may be designed and shaped separately to mate with the first component in assembly. The second component may comprise a bottom half, a right half, or another portion of the product configured to mate with the first component.

At a step 1406, both formed components are trimmed. The trimming removes excess flash material around the margins of the thermoformed parts. In some cases, the trimming may be performed using manual cutting tools. In some cases, the trimming may be performed using automated cutting equipment. The trimming prepares the first component and the second component for assembly by removing material that extends beyond the intended boundaries of the finished product.

At a step 1408, adhesive is applied to bonding surfaces. The adhesive may be applied along surfaces of the first component and the second component where the first component and the second component will meet during assembly. In some cases, the adhesive may be applied around a perimeter of the components where the first component and the second component will be joined. In some cases, an air-actuated glue gun may be used to apply the adhesive.

At a step 1410, the components are assembled and bonded together. The first component and the second component are brought together with the adhesive applied at the step 1408 positioned between bonding surfaces of the first component and the second component. The first component and the second component may be aligned and pressed together to form an enclosed structure. In some cases, the first component and the second component may be bonded together using plastic welding instead of or in addition to adhesives. In some cases, the first component and the second component may be joined using fasteners such as screws or rivets, or a combination of fastening systems.

At a step 1412, the adhesive is allowed to cure. The assembled product is held in position while the adhesive cures to complete the bonding between the first component and the second component. The curing time may vary depending on the type of adhesive used and the ambient temperature conditions. In some cases, the assembled product may be held in a fixture during curing to maintain alignment between the first component and the second component.

At a step 1414, the edges of the assembled product are trimmed. After the adhesive cures, the edges of the assembled product may be trimmed to provide a finished appearance and remove any excess material at the joint locations. In some cases, a CNC trim of the edges may be performed to provide precise edge finishing. In some cases, the trimming at the step 1414 may also create openings for access hatches, equipment mounting, or other features in the assembled product.

### One-Piece Cambered Stabilizer

Referring to FIG. 15, a one-piece formed stabilizer with camber 1550 formed from a multiwall plastic sheet 1500 is shown. The multiwall plastic sheet 1500 is depicted as a flat rectangular sheet with visible internal web walls characteristic of multiwall material. The multiwall plastic sheet 1500 may comprise multiwall thermoplastic material such as polycarbonate or polypropylene.

The thermoforming process transforms the multiwall plastic sheet 1500 from a flat configuration into the formed stabilizer with camber 1550 having an airfoil 1510 shape. The airfoil 1510 exhibits a cambered profile where an upper surface has a different curvature than a lower surface, creating an asymmetrical cross-section. The asymmetrical curvature of the airfoil 1510 may provide aerodynamic characteristics suitable for various applications including stabilizers, canards, and wings that are too small for conventional two-skin construction.

In some cases, the formed stabilizer with camber 1550 may be formed using the thermoforming process described above with reference to FIGS. 5 and 6. The multiwall plastic sheet 1500 may be heated until pliable and then formed between two outer molds. The two outer molds shape both surfaces of the multiwall plastic sheet 1500 simultaneously to create the airfoil 1510 shape with the cambered profile. The formed stabilizer with camber 1550 is formed from a single piece of multiwall material, resulting in a complete stabilizer structure without requiring subsequent bonding of separate top and bottom halves.

The internal structure of the multiwall plastic sheet 1500 is visible within the formed airfoil 1510, showing how the internal web walls have been shaped during the thermoforming process to conform to the airfoil geometry. As described above, the internal web walls may be stretched during forming and may cool to provide structural support between the first wall and the second wall within the formed stabilizer with camber 1550.

A trim line 1520 is indicated at the leading edge of the formed stabilizer with camber 1550. The trim line 1520 shows where excess material is to be removed during assembly. The excess material at the trim line 1520 is a natural result of the vacuum forming process and may be trimmed before the formed stabilizer with camber 1550 is assembled into a finished aircraft structure.

In some cases, the formed stabilizer may have a symmetrical cross section where a top skin is a mirror image of a bottom skin. In some cases, the formed stabilizer may have a non-symmetrical cambered airfoil cross section as shown in FIG. 15. The selection of a symmetrical or cambered profile may depend on the aerodynamic requirements of the aircraft design.

### One-Piece Symmetrical Stabilizer

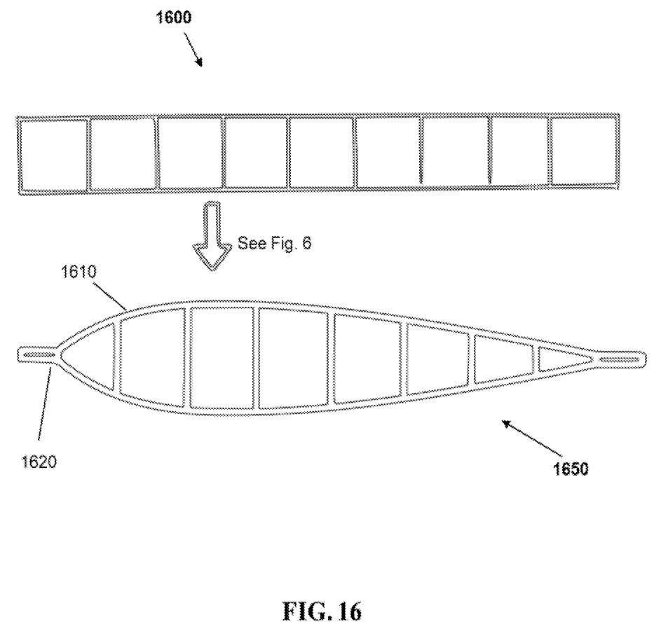

Referring to FIG. 16, a one-piece formed symmetrical stabilizer 1650 formed from a multiwall plastic sheet 1600 is shown. The multiwall plastic sheet 1600 is depicted as a flat rectangular sheet shown in cross-section with visible internal web walls characteristic of multiwall material. The multiwall plastic sheet 1600 may comprise multiwall thermoplastic material such as polycarbonate or polypropylene.

The thermoforming process transforms the multiwall plastic sheet 1600 from a flat configuration into the formed symmetrical stabilizer 1650 having an airfoil 1610 shape. The airfoil 1610 exhibits a symmetrical profile where an upper surface and a lower surface have equal curvature, creating a symmetrical cross-section. The equal curvature of the upper and lower surfaces of the airfoil 1610 may provide aerodynamic characteristics suitable for horizontal stabilizer applications where symmetrical lift characteristics are desired.

In some cases, the formed symmetrical stabilizer 1650 may be formed using the thermoforming process described above with reference to FIGS. 5 and 6. The multiwall plastic sheet 1600 may be heated until pliable and then formed between two outer molds. The two outer molds shape both surfaces of the multiwall plastic sheet 1600 simultaneously to create the airfoil 1610 shape with the symmetrical profile. In some cases, the multiwall plastic sheet 1600 may have a thickness of approximately 12 millimeters or other thicknesses suitable for the stabilizer application. The formed symmetrical stabilizer 1650 results in a complete stabilizer structure from a single piece of multiwall material without requiring subsequent bonding of separate top and bottom halves.

The internal structure of the multiwall plastic sheet 1600 is visible within the formed airfoil 1610, showing how the internal web walls have been stretched and shaped during the thermoforming process to conform to the airfoil geometry. As described above, the internal web walls may be stretched during forming and may cool to provide structural support between the first wall and the second wall within the formed symmetrical stabilizer 1650.

A trim line 1620 is indicated at the leading edge of the formed symmetrical stabilizer 1650. The trim line 1620 shows where excess material is to be removed during assembly. The excess material at the trim line 1620 is a natural result of the vacuum forming process and may be trimmed before the formed symmetrical stabilizer 1650 is assembled into a finished aircraft structure.

The formed symmetrical stabilizer 1650 demonstrates how a thick multiwall sheet can be formed between two outer molds to create a part with a solid cross section rather than stiffened skins. In some cases, the two outer molds may shape both exterior surfaces of the multiwall material to create the desired airfoil geometry. The solid cross-section construction of the formed symmetrical stabilizer 1650 may be suitable for smaller aircraft components such as stabilizers and vertical fins where the thickness of the multiwall material provides sufficient structural depth to form a complete airfoil profile.

### Advantages

The methods and materials disclosed herein provide several advantages for manufacturing aircraft components and other products. Thermoforming multiwall thermoplastic sheets using vacuum molds enables rapid production of lightweight structural components with favorable strength-to-weight characteristics. The dual-mold vacuum forming process allows both surfaces of the multiwall material to be precisely shaped simultaneously, enabling complex three-dimensional geometries while preserving the structural benefits of the internal web walls. The internal web walls stretch during forming and cool to provide inherent structural support without requiring additional foam core or internal reinforcement materials. The thermoforming process offers shorter cycle times and lower tooling costs compared to carbon fiber layup or metal forming processes. Assembly of thermoformed components using adhesive bonding or plastic welding enables efficient construction of complete aircraft structures from a minimal number of parts. The ability to form mounting features, spar recesses, and equipment accommodations directly into the thermoformed parts during the molding process reduces secondary machining operations and simplifies assembly. The use of commercially available multiwall polycarbonate and polypropylene sheets provides material cost advantages and supply chain flexibility compared to specialty aerospace materials.

A number of implementations have been described. Nevertheless, it will be understood that various modifications may be made without departing from the spirit and scope of the disclosure. Accordingly, other implementations are within the scope of the following claims.

1. A method for manufacturing a component part, the method comprising:
providing a sheet of multiwall thermoplastic material, the multiwall thermoplastic material comprising a first wall having a first planar surface, a second wall having a second planar surface spaced apart from the first planar surface, and a plurality of internal web walls extending between the first wall and the second wall;
heating the sheet until the multiwall thermoplastic material becomes pliable;
positioning the heated sheet between a first mold half and a second mold half of a vacuum mold, wherein the first mold half defines a first mold surface and the second mold half defines a second mold surface;
closing the vacuum mold to compress the heated sheet between the first mold half and the second mold half;
applying vacuum suction to both the first mold half and the second mold half simultaneously to draw the first planar surface against the first mold surface and the second planar surface against the second mold surface, thereby forming a shaped component; and
removing the shaped component from the vacuum mold.

2. The method of claim 1, wherein the internal web walls are stretched during forming and cool to provide structural support between the first wall and the second wall.

3. The method of claim 1, wherein the first mold half and the second mold half are coupled by a pivotable coupling.

4. The method of claim 1, wherein a shape of the first mold surface is different from a shape of the second mold surface.

5. The method of claim 4, wherein the first mold surface is a smooth, uniform surface, and the second mold surface comprises at least one recess configured to form a corresponding channel in the shaped component for receiving an internal aircraft component.

6. The method of claim 5, wherein the internal aircraft component comprises a structural support.

7. The method of claim 6, wherein the structural support comprises a spar.

8. The method of claim 5, wherein the at least one recess is configured to form at least one of: a slot for receiving a wing spar or wing rib, a planar mounting surface for internal equipment, and a non-planar recess for indexing or mounting equipment.

9. The method of claim 1, further comprising:
forming a second shaped component; and
bonding the shaped component to the second shaped component to form an assembled structure.

10. The method of claim 9, further comprising positioning a spar between the shaped component and the second shaped component prior to bonding, wherein the spar is received within channels formed in the shaped component and the second shaped component.

11. The method of claim 1, wherein the shaped component comprises a wing skin having an upper surface portion and a lower surface portion formed as a single contiguous piece, the method further comprising:
folding the wing skin about a leading edge to bring the upper surface portion and the lower surface portion into opposition; and
bonding the upper surface portion to the lower surface portion along a trailing edge to form a wing.

12. The method of claim 1, further comprising securing the sheet in a frame prior to heating.

13. The method of claim 1, wherein the multiwall thermoplastic material comprises at least one of polycarbonate and polypropylene.

14. An aircraft component comprising:
a structural body formed from a sheet of multiwall thermoplastic material, the multiwall thermoplastic material comprising:
a first wall having a first planar surface,
a second wall having a second planar surface spaced apart from the first planar surface, and
a plurality of internal web walls extending between the first wall and the second wall;
wherein the sheet of multiwall thermoplastic material has been transformed from an originally flat configuration into a three-dimensional shape by thermoforming such that the first planar surface defines a first formed surface, and the second planar surface defines a second surface.

15. The aircraft component of claim 14, wherein the second surface comprises at least one slot configured to receive at least one of a wing spar and a wing rib.

16. The aircraft component of claim 14, wherein the second surface comprises at least one mounting feature configured for receiving an internal component.

17. The aircraft component of claim 16, wherein the at least one mounting feature comprises at least one of a planar mounting surface and a non-planar recess.

18. The aircraft component of claim 16, wherein the internal component comprises at least one of a battery, a flight controller, a mission payload, a radio, a servo, a motor mount, and a fuel tank.

19. The aircraft component of claim 14, wherein the internal web walls have been stretched during thermoforming and have cooled to provide structural support between the first wall and the second wall.

20. The aircraft component of claim 14, wherein the multiwall thermoplastic material comprises at least one of polycarbonate and polypropylene.
